(19) United States
(12) Patent Application Publication
(10) Pub. No.: US 2013/0343575 A1
(43) Pub. Date: Dec. 26, 2013

(54) CARD READING APPARATUS FOR USE WITH PERSONAL HANDHELD DEVICE

(71) Applicant: Wen-Chi LU, Taipei City (TW)

(72) Inventor: Wen-Chi LU, Taipei City (TW)

(21) Appl. No.: 13/565,144

(22) Filed: Aug. 2, 2012

(30) Foreign Application Priority Data
Jun. 22, 2012 (TW) 101212112

(51) Int. Cl. H04R 3/00

(52) U.S. Cl. 381/111

(57) ABSTRACT

A card reading apparatus for use with a personal handheld device is provided, wherein the personal handheld device has an audio socket for connecting with earphones or other corresponding devices. The card reading apparatus includes: a battery unit; a voltage stabilizer unit; a microcontrol unit; a contact terminal module; a digital-to-analog converter electrically connected to the microcontrol unit; an audio plug electrically connected to the digital-to-analog converter and removably connectable with the audio socket of the personal handheld device; and a mobile application program (APP) stored in a recording medium so as to be installed in the personal handheld device, wherein the mobile application program can interpret the data transmitted from the microcontrol unit through the digital-to-analog converter and the audio plug.

### BACKGROUND OF THE INVENTION

1. Technical Field

The present invention relates to an apparatus for reading electronic cards and, more particularly, to a card reading apparatus for use with a personal handheld device.

2. Description of Related Art

Card reading apparatuses are well known in the art. For example, U.S. Pat. No. 7,337,259 discloses a smart card reading apparatus with a Universal Serial Bus (USB) hub, wherein the smart card reading apparatus can be connected to a computer through a USB interface so as for the computer to read smart cards.

On the other hand, personal handheld devices such as smart phones and tablet computers are more and more powerful and, thanks to their growing network connectivity, have become almost as capable as personal computers. In particular, it is now technically feasible to carry out transactional behaviors (e.g., payment to an online bank, having a credit card charged, etc.) through the Internet using a personal handheld device. To have a credit card charged in this way requires an apparatus both connectable to the personal handheld device and capable of reading the credit card.

Presently, the external connection interfaces provided by personal handheld devices vary from brand to brand in terms of specifications. The different specifications limit the types of personal handheld devices with which a conventional USB card reader can be used. By contrast, most personal handheld devices have the same audio sockets for insertion by an audio plug in order to play music files in MP3 or other formats. Hence, the issue to be addressed by the present invention is to use this common audio socket interface to connect a personal handheld device and a card reading apparatus, thereby enabling the personal handheld device to read smart cards and/or credit cards.

### BRIEF SUMMARY OF THE INVENTION

The primary object of the present invention is to provide a card reading apparatus for use with a personal handheld device, wherein an audio socket of the personal handheld device serves as a connection interface that enables the personal handheld device to read smart cards and/or credit cards.

To achieve the above and other objects, the present invention provides a card reading apparatus for use with a personal handheld device, wherein the personal handheld device has an audio socket for connecting with earphones or other corresponding devices. The card reading apparatus includes: a battery unit; a voltage stabilizer unit electrically connected to the battery unit; a microcontrol unit electrically connected to the voltage stabilizer unit; a contact terminal module which is electrically connected to the microcontrol unit and is connectable with the contacts of a card so as to read data from the card; a digital-to-analog converter electrically connected to the microcontrol unit; an audio plug which is electrically connected to the digital-to-analog converter and is removably connectable with the audio socket of the personal handheld socket; and a mobile application program (APP) which is stored in a recording medium so as to be installed in the personal handheld device, wherein the mobile application program can interpret the data transmitted from the microcontrol unit through the digital-to-analog converter and the audio plug.

Preferably, the card reading apparatus further includes a housing in which the battery unit, the voltage stabilizer unit, the microcontrol unit, the contact terminal module, the digital-to-analog converter and the audio plug are provided. The housing has an insertion slot into which the card can be inserted. The contact terminal module is located in the insertion slot and is connected to the contacts of the card upon insertion of the card.

Preferably, the contact terminal module has a plurality of contact terminals and further has a card insertion detection terminal electrically connected to the battery unit and the microcontrol unit.

Preferably, the recording medium is an optical disc or a storage space provided by a server in the Internet.

### BRIEF DESCRIPTION OF THE SEVERAL VIEWS OF THE DRAWINGS

The structure and features of the present invention will be best understood by referring to the following detailed description of the preferred embodiments in conjunction with the accompanying drawings, in which:

FIG. 1 is a circuit block diagram of a preferred embodiment of the present invention;

FIG. 2 is an assembled perspective view of the preferred embodiment of the present invention;

FIG. 3 is an exploded perspective view of the preferred embodiment of the present invention; and

FIG. 4 is a circuit block diagram of another preferred embodiment of the present invention.

### DETAILED DESCRIPTION OF THE INVENTION

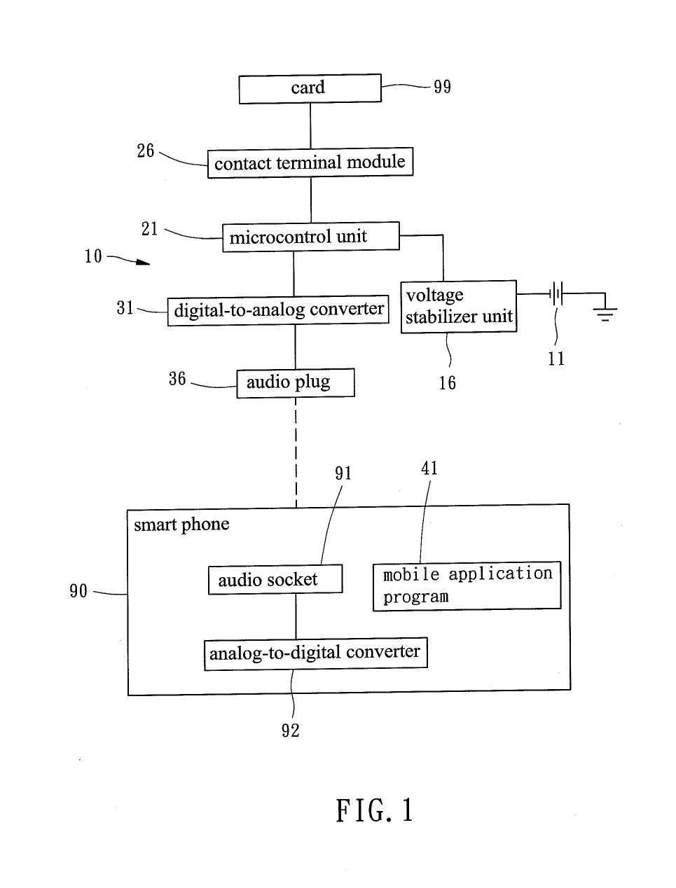

Referring to FIG. 1 for a preferred embodiment of the present invention, a card reading apparatus 10 is configured for use with a personal handheld device 90, wherein the personal handheld device 90 has an audio socket 91 for connecting with earphones (not shown) or other corresponding devices. The card reading apparatus 10 essentially includes a battery unit 11, a voltage stabilizer unit 16, a microcontrol unit 21, a contact terminal module 26, a digital-to-analog converter 31, an audio plug 36 and a mobile application program (APP) 41.

The battery unit 11 serves to supply electric power.

The voltage stabilizer unit 16 is electrically connected to the battery unit 11 and is configured for converting the electric power provided by the battery unit 11 into a stable voltage.

The microcontrol unit 21 is electrically connected to the voltage stabilizer unit 16.

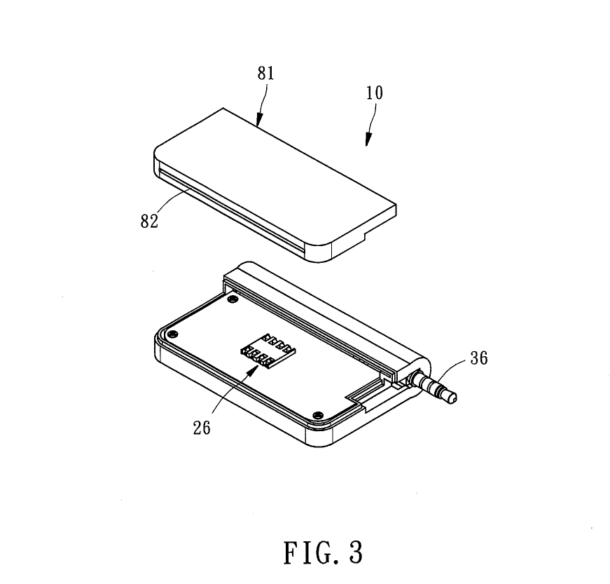

The contact terminal module 26 is electrically connected to the microcontrol unit 21 and is configured for connecting with the contacts (not shown) of a card 99 (e.g., a smart card or credit card) so as to read data from the card 99. The contact terminal module 26 includes a plurality of contact terminals (see FIG. 3).

The digital-to-analog converter 31 is electrically connected to the microcontrol unit 21.

The audio plug 36 is electrically connected to the digital-to-analog converter 31 and can be connected with the audio socket 91 of the personal handheld device 90 in a removable manner.

The mobile application program 41 is stored in a recording medium (not shown) so as to be installed in the personal handheld device 90. The mobile application program 41 is designed to interpret the data transmitted from the microcontrol unit 21 through the digital-to-analog converter 31 and the audio plug 36. In this embodiment, the recording medium can be an optical disc, a USB flash drive or a storage space provided by a server in the Internet so that a user can download the mobile application program 41 via the Internet.

The personal handheld device 90 itself has an analog-to-digital converter electrically connected to the audio socket 91, which converter and connection are well known in the art and therefore will not be described herein. The analog-to-digital converter can convert the analog signals obtained through the audio socket 91 into digital signals, so as for the personal handheld device 90 to read external data transmitted through the audio socket 91.

To use the card reading apparatus 10, the audio plug 36 is inserted into the audio socket 91 of the personal handheld device 90, and the contacts of the card 99 are connected with the contact terminal module 26. The microcontrol unit 21 then reads data from the card 99 and sends the data to the digital-to-analog converter 31, where the data are converted into analog signals. The analog signals are transmitted to the personal handheld device 90 through the audio plug 36. Once the personal handheld device 90 receives the analog signals, the analog-to-digital converter 92 of the personal handheld device 90 converts the analog signals into digital signals, which are interpreted by the mobile application program 41 installed in the personal handheld device 90. Thus, the reading of the card 99 is completed, and the data thus read can be subsequently used in a credit card transaction or online transaction. As subsequent use of the data is irrelevant to the present invention, no further description is provided in this regard.

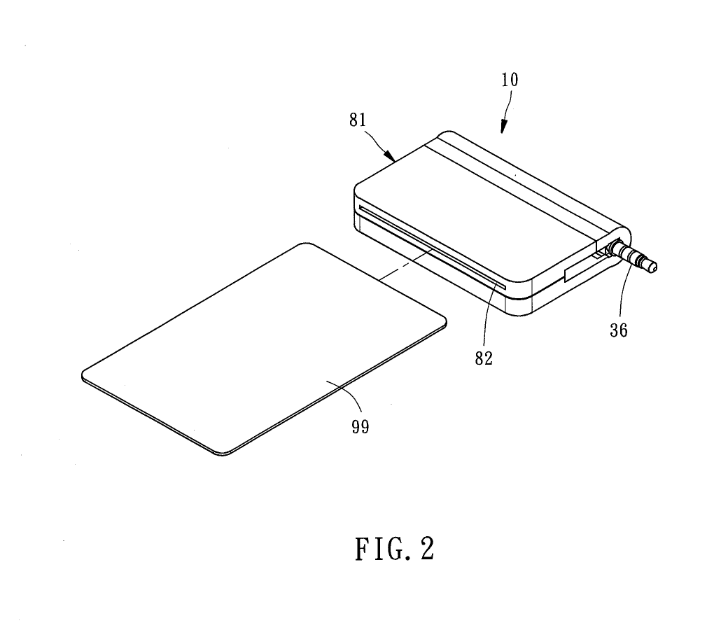

As shown in FIG. 2 and FIG. 3, implementation of the present invention may involve a housing 81 for housing the battery unit 11, the voltage stabilizer unit 16, the microcontrol unit 21, the contact terminal module 26, the digital-to-analog converter 31 and the audio plug 36. The housing 81 further has an insertion slot 82 into which the card 99 can be inserted. The contact terminal module 26 is located in the insertion slot 82 and, once the card 99 is inserted in the insertion slot 82, is connect with the contacts of the card 99.

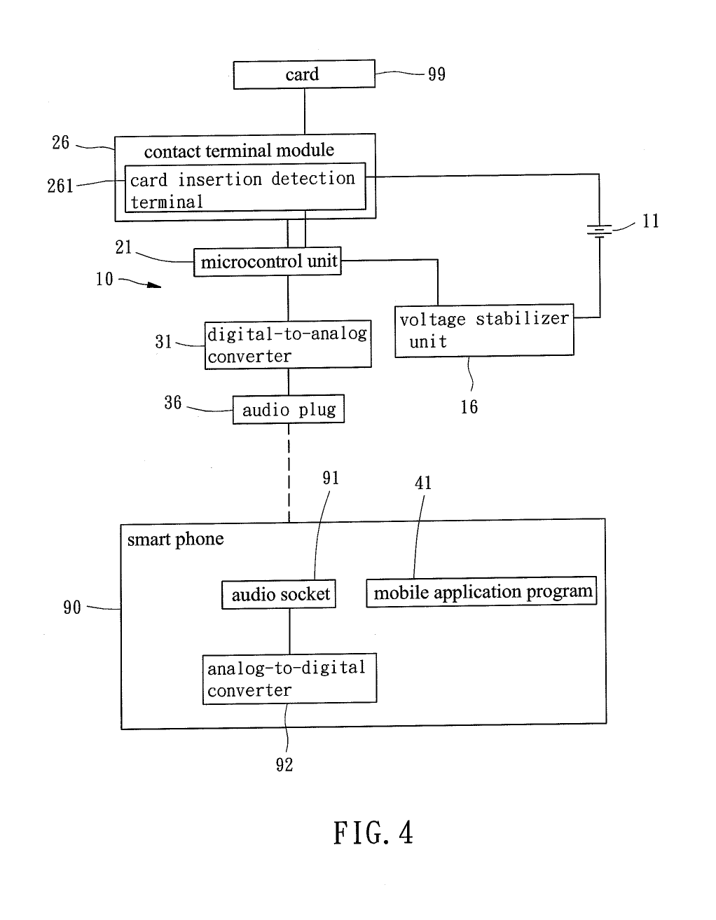

It should be added that, as shown in FIG. 4, the contact terminal module 26 may further have a card insertion detection terminal 261 electrically connected to both the battery unit 11 and the microcontrol unit 21. Through the card insertion detection terminal 261, the microcontrol unit 21 can detect whether a card has been inserted and thereby determines whether the foregoing card reading operation should be performed.

According to the above, the present invention uses an audio socket of a personal handheld device as the connection interface and thereby enables the personal handheld device to read smart cards and/or credit cards.

What is claimed is:

1. A card reading apparatus for use with a personal handheld device, wherein the personal handheld device has an audio socket for connecting with earphones or other corresponding devices, the card reading apparatus comprising:
a battery unit;
a voltage stabilizer unit electrically connected to the battery unit;
a microcontrol unit electrically connected to the voltage stabilizer unit;
a contact terminal module electrically connected to the microcontrol unit and configured for connecting with contacts of a card and thereby reading data from the card;
a digital-to-analog converter electrically connected to the microcontrol unit;
an audio plug electrically connected to the digital-to-analog converter and removably connectable with the audio socket of the personal handheld device; and
a mobile application program (APP) stored in a recording medium so as to be installed in the personal handheld device, wherein the mobile application program can interpret data transmitted from the microcontrol unit through the digital-to-analog converter and the audio plug.

2. The card reading apparatus of claim 1, further comprising a housing for housing the battery unit, the voltage stabilizer unit, the microcontrol unit, the contact terminal module, the digital-to-analog converter and the audio plug, the housing having an insertion slot into which the card is insertable, wherein the contact terminal module is located in the insertion slot and is connected with the contacts of the card after the card is inserted into the insertion slot.

3. The card reading apparatus of claim 1, wherein the contact terminal module comprises a plurality of contact terminals and a card insertion detection terminal, the card insertion detection terminal being electrically connected to the battery unit and the microcontrol unit.

4. The card reading apparatus of claim 1, wherein the recording medium is an optical disc, a Universal Serial Bus (USB) flash drive, or a storage space provided by a server in the Internet.
